(19) United States
(12) Patent Application Publication
(10) Pub. No.: US 2006/0079121 A1
(43) Pub. Date: Apr. 13, 2006

(54) Twistable connector and provider assembly

(76) Inventor: Mark Anthony Bruno, Dearborn, MI (US)

Correspondence Address: Mark A. Bruno, 5200 Heather Dr. APT 115, Dearborn, MI, 48126, US

(21) Appl. No.: 10/117,582

(22) Filed: Apr. 5, 2002

Related U.S. Application Data
(63) Continuation of application No. 09/748,880, filed on Dec. 27, 2000, now abandoned.

(51) Int. Cl. H01R 11/00

(52) U.S. Cl. 439/502

(57) ABSTRACT

A twistable electrical connector for computer periphery devices, primarily, in the form of an interface which allows the user to turn the connector at least ninety degrees, such that one can fit the device into places a standard connector will not fit. In the preferred mode, a flexible, semi-rigid plastic pipe construction separates the diversified connector types and extends the twistable connection. Both ends could be any type of interface, as determined by periphery, or items required, where as, each twistable connector consists of a left connector assembly, a right connector assembly and an assembly of semi-rigid plastic constructions, forming the pipe, in which the internal cabling interfacing the 2 connector resides.

### DESCRIPTION OF PRIOR ART

The Twistable connector concept recites several patent classes in an effect to justify the logic of such an interconnect idea. The semi-rigid extension is supported by U.S. Pat. Nos. 3,82,536, 3,561,492, 2,994,050 and others. This recitation only supplies examples of presently employed methods utilizing semi-rigid conduit. In order for the Twistable connector to be serviceable as an interface, it must have an interface and interconnections to facilitate signal flow between the interconnections. Patent numbers such as; U.S. Pat. Nos. 4,846,731, 4,274,691, 4,224,486, 3,840,839, 4,408,822, 4,255,011, 3,184,706, 3,107,135, and 1,370,789 detail types of possible interfaces that might be employed by a Twistable connector, while patent numbers such as; U.S. Pat. No. 3,187,495, 3,090,825, 5,113,039, 5,068,632 and 3,408,453 detail some of the types of wiring that might be employed to service as the interconnection paths.

Proposed changes and additions to the drawings are enclosed herewith. FIGS. 1a, 1b, 1c, 1d, 2, 3, 4a, 4b, 4c, and 4d. These drawing will further describe the presented invention.

### BACKGROUND OF THE INVENTION

This invention generally relates to the problem of interfacing devices to a computer system. This invention also relates to the present cabling, in the sense that cabling used today is flexible, but does not retain position. These two issues, interfacing and position, create issues to a user, who must interface the device, and then attempt to neatly position the cabling, which interconnects the devices.

### SUMMARY OF THE INVENTION

In accordance with the presented invention, the Twistable connector and provider assembly provides a user with a convenient solution to interfacing issues, by presenting a semi-rigid extension with the necessary connections on both ends. This configuration allows user convenience when a device is attached to a receiving device using the Twistable connector and provider assembly. A Twistable connector would be attached to the receiving device, such as, a computer printer port, and then a user would attach the device to the semi-rigid interconnection, without accessing the rear of the receiving device, making a convenient, accessible connection.

Also, in accordance with the presented invention that addresses the issue of flexible cables that do not retain the position set. The Twistable connector, using a semi-rigid extension tube, does allow a user to set an initial cabling position, which will remain in place until some external force acts to change the position. Flexible cable change position because of gravity, and the presented invention is not effected by gravity and the relative position.

The cabling used is flexible, but it will be enclosed within the semi-rigid extension, which forms a type of conduit the cabling will reside within, while interconnecting the devices to each other. Inclosing the cabling within this tube allows the user convenient accessibility, and stable positional configurations.

### BRIEF DESCRIPTION OF THE PRESENTED DRAWINGS

FIGS. 1a, 1b, 1c, Details the interlocking member sized at 1″ by 1.5″.

FIG 1d, details an assembly of interlocking members, with a cabling example enclosed.

FIG. 2 Details the ball end connector molds, and

FIG. 3 shows the socket end connector molds.

FIG. 4a details an assembly of interlocking members, with a ball end connector and a socket end connector attached.

FIG. 4b details the assembly of parts within a ball or socket end connector.

FIG. 4c displays an interconnection of members, with a twist.

FIG. 4d details an example assembly as a complete unit

### DETAIL DESCRIPTION OF THE PRESENTED DRAWINGS

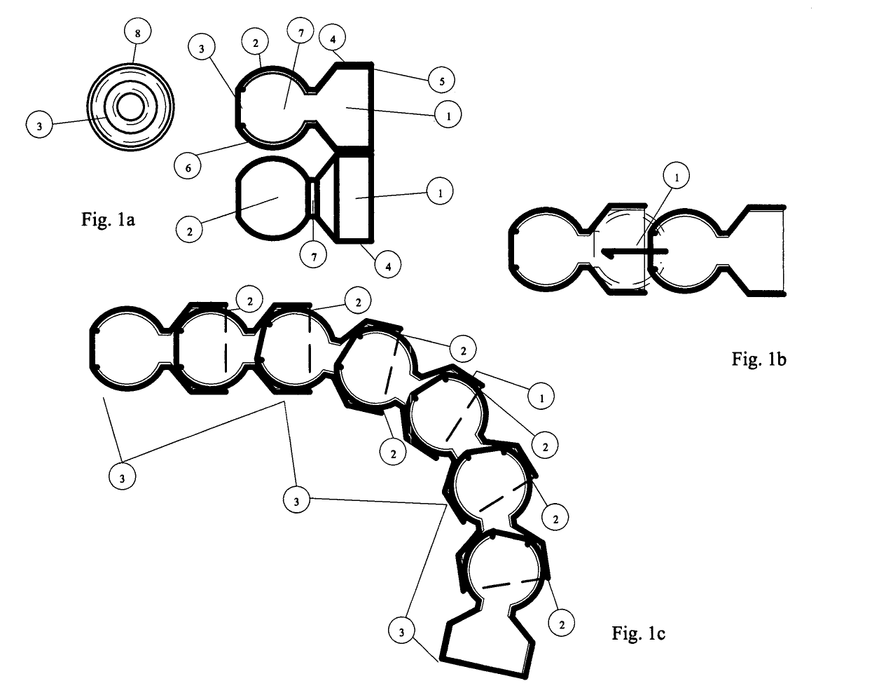

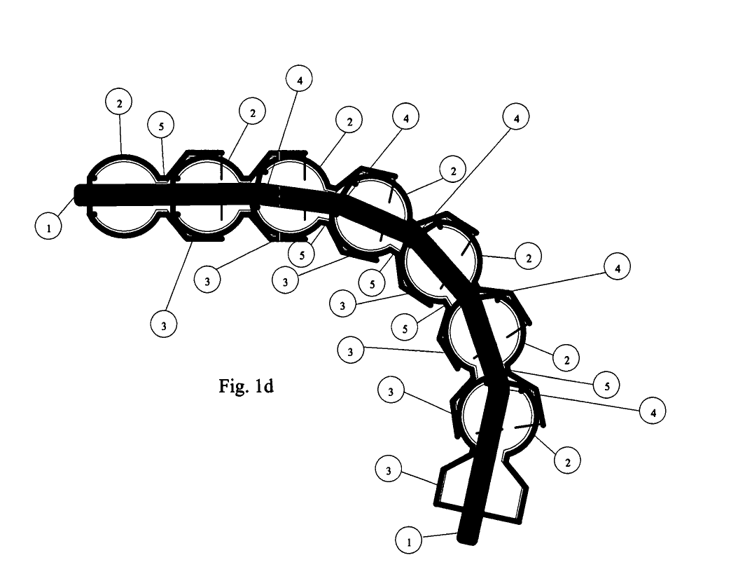

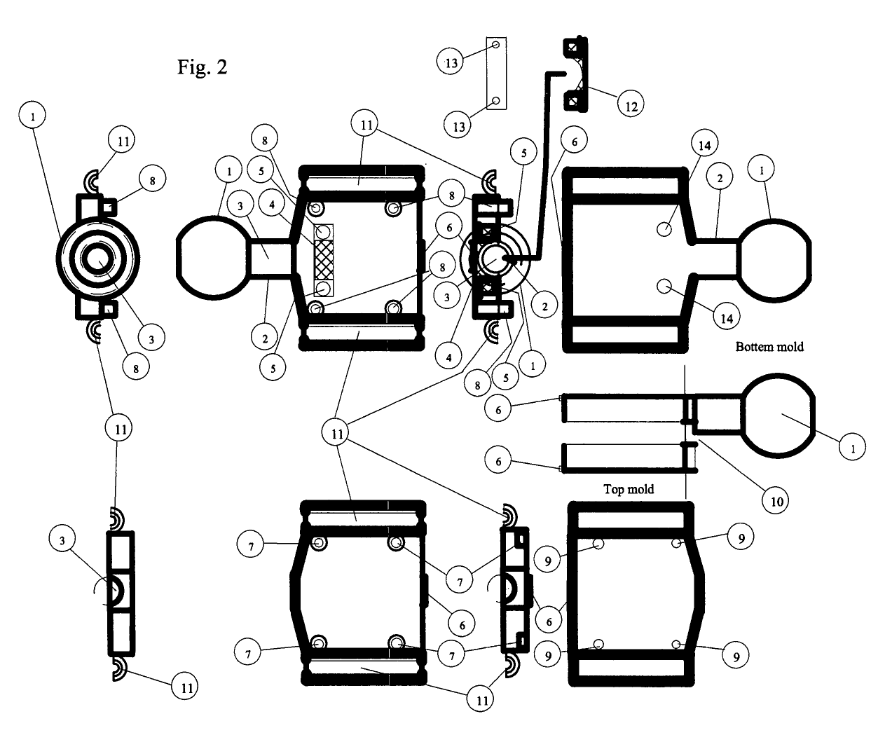

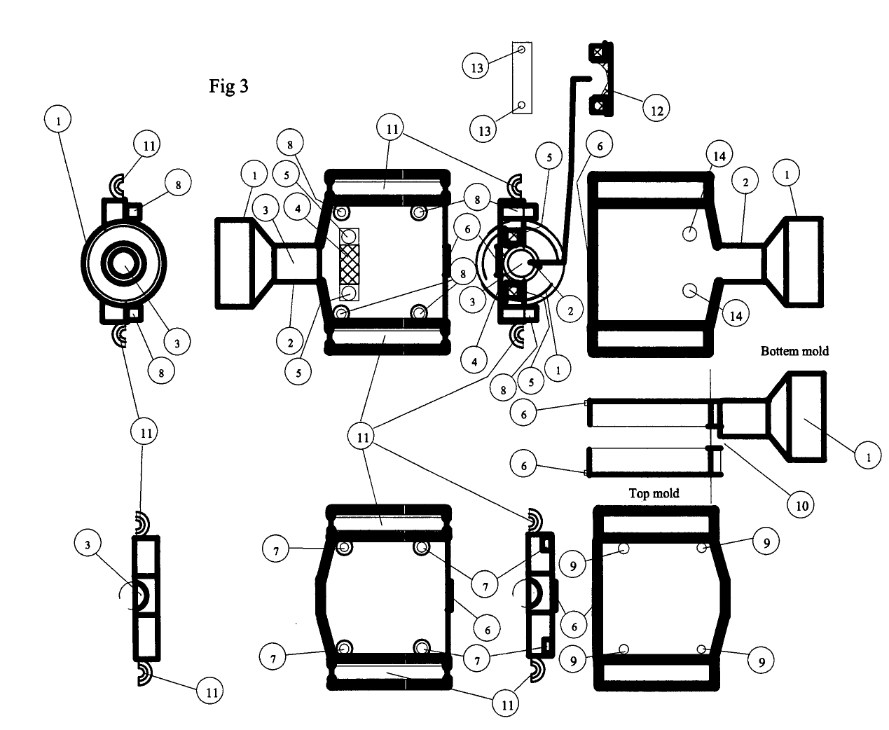

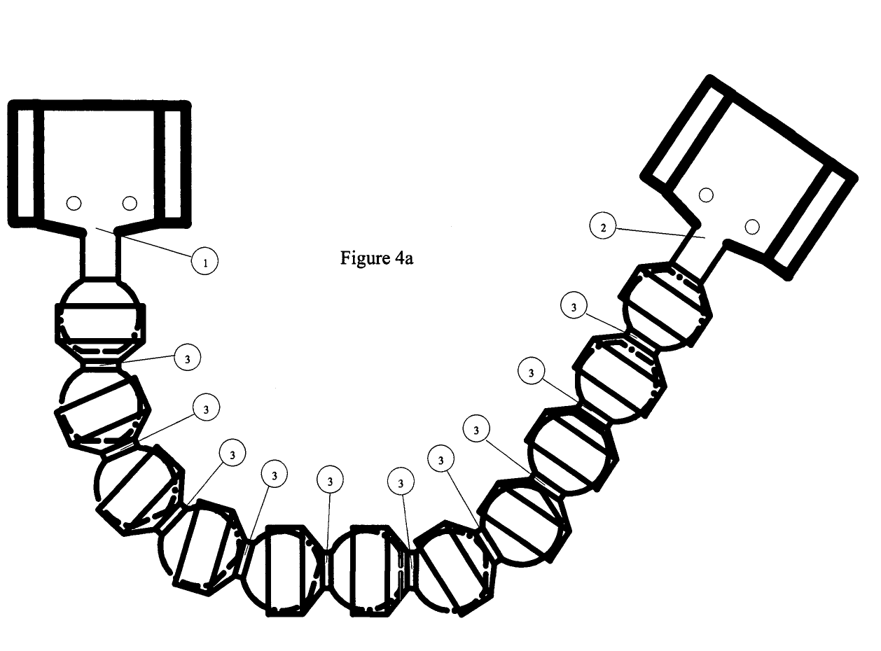

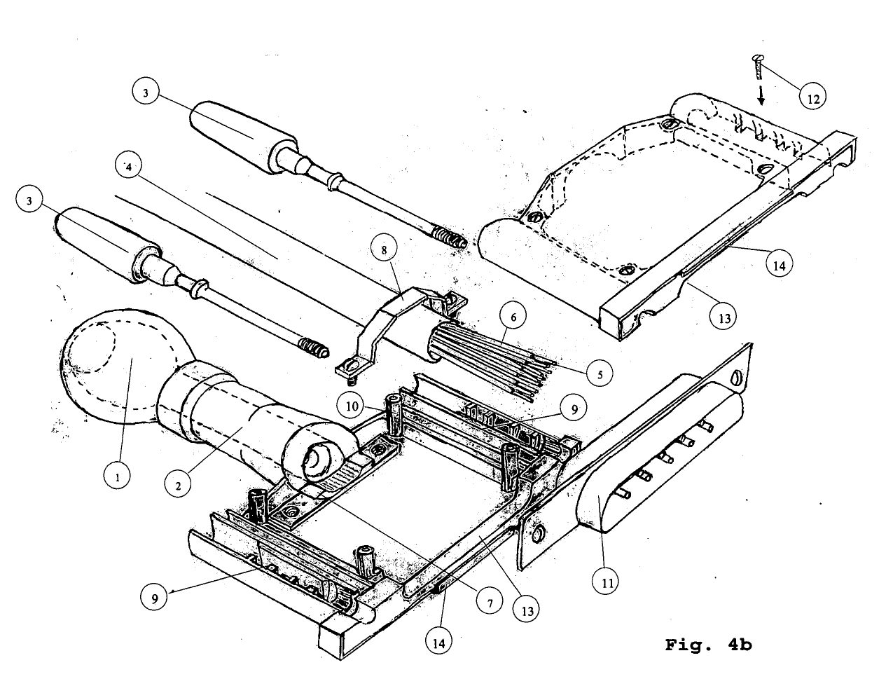

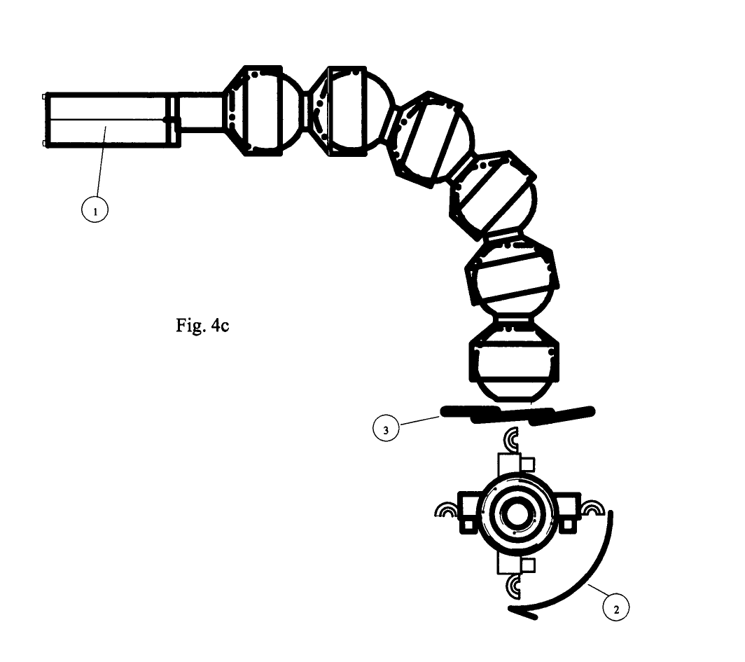

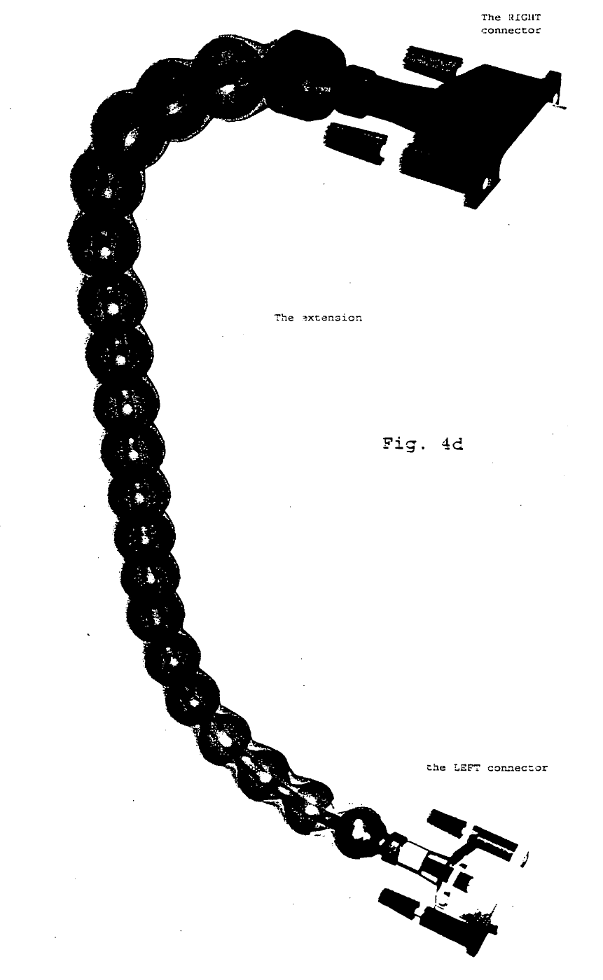

FIG 1a; 1—The socket end of an interlocking member detailed in a cut away depiction. 2—The socket end of an interlocking member, which is also detailed in the cut away depiction. 3—Depicts the ball end opening, which is designed to allow cable bending within the interlocking member, this opening does limit the amount of bend within the interlocking member. 4 —Details the diameter of the socket, which is 1.5″ in this example. The preferred embodiment can be of 4 sizes, being the example at 1″ by 1.5″, 2″ by 3″ the largest, (1″ by 1.5″)*0.75, and the smallest being (1″ by 1.5″)*0.25. 5—Shows the inner diameter of the socket, in which the ball fits inside. This inside diameter is an exact match to the outside diameter of the ball, allowing the ball to rest inside the socket. 6—Details the interlocking member's wall structure, which in the preferred embodiment is ¼″ molded with PVC injected plastic. 7—Shows the interlocking member's WIRE-WAY, which allows the passage of a cable within the member. This wire-way extends from the opening, 3 to the neck 7 at an angle in three dimensional space, as a cone. 8—Is a top view of the interlocking member with three circle lines detailing diameters with relation of a ball end to a socket end. FIG 1b 1—This is a depiction of the preferred embodiment and 2 interlocking members, with a ball of one member inserted into the socket of a second member, forming the basis of an assembly of members. FIG 1c 1—Within this diagram the detail of how the interlocking members interlock is displayed. Each ball of one member fits exactly within each socket of a second member, giving the assembly form, connectivity, and the member's semi-rigid properties. 2—Since the diameters of the inside of the socket and the outside of the ball are the same, the assembled structure depicted here, allows the structure to remain intact, while utilizing the self lubricating properties exiting in PVC plastics. 3—Depicts the assembly, cut away, with a system bend of six interlocking members. FIG. 1d 1—Depicts an abstract cable inside a system of interlocking members, which have been cut away. Within this depiction the abstract cable is ⅜″ diameter, and could be of less diameter, but the preferred only requires that a cable or tube be present and of equal or less diameter, when a member is at the example's size (1″ by 1.5″). IE, the larger the member the larger the diameter the cable can be. 2 and 3—Depicts the ball and socket as detailed in FIGS. 1a, 2 and 3, but within a system of interlocking members. 4—Shows the abstract cable within the described WIRE-WAY, FIG. 1a 7. FIG. 2 1—Details the ball on one of the ball side connector molds, which is on the bottom connector mold. 3—Depicts the ball side connect end, bottom mold, WIRE-WAY, which can be referred to as the, 2—connector NECK. 4—Is the cable anchor, which in the preferred embodiment allows a point to attach, anchor a pre-manufactured cable. This incorporated subassembly is a part of the bottom connector mold. 5—Represents the holes that allow the attachment of item 12, using screws, which in turn secure the cable to the anchor, IE STRAIN RELIEF. 6—Is the physical connector, retainer clips, which are a part of the top and bottom connector molds. 7—Details the methodology used in the preferred embodiment for the attachment of the bottom mold onto the top mold, which allow self tapping screws to be feed though 7, and tapped into 8, but limited by the size of the, 9, holes, on the top mold. 9—Allows the top to be secured onto the bottom mold, because of the difference in the sizes of the holes. 10—Shows the manner in which the top mold and bottom attach, via a side view. 11—Represents the retain hardware cavity, which provides limits in movement of retaining hardware attachments. 12—As noted within item 5, item 12 represents the top half of the anchoring point, this construction is a separate mold, attached in the assembly of a connector half, while 13—is the holes in which retaining screws are attached. Also 14—details the manner in which the limiting holes on the top connector, allow for the attachment of anchoring points, this does provide a secure anchor for any cable or tube using compression methodologies. FIG. 3 is the same structure and methodology as the depiction represented by FIG. 2, except that the mold in FIG. 3 1—has a socket instead of a ball, note how the ball connector mold can be attached directly to the socket connector mold using the assembly presented by FIG 1d. FIG. 4a 1—shows a ball side connector attaching to an assembly of members, 3, while 2—shows the connectivity of a socket side connector to an assembly of members, again 3. FIG. 4b Depicts the assembly of the ball side connector with all the associate parts and features of the ball side, but does not detail the socket side connector, which is the same except as noted by FIG. 3. FIG. 4b 1—shows a three dimensional view of the ball of the bottom mold on the ball side connector. 2—Represents a three dimensional view of the connector neck. 3—Are depictions of the two retaining screws. 4—Is a representation of the jacket on a pre-manufactured cable, and 5—represents the 22 AWG wiring pin, which is a part of; 6—, the wire jacket, which is generally color coded. As noted, the cable has wires inside, forming a multi-conductor cable, with wire a defined gage, therefore the gage of individual wire does dictate the over size of the chosen cabling, except in the case IF/RF cabling are chosen. 7—Represents the three dimensional view of the integrated bottom half cable anchor assembly, while 8—forms the top half of the anchor which allows the cable/tube to be attached using compression, as noted. See the screws which shown on 8. 9—Again, represents the retaining screws a cavity which limits the movement of item 3, IE item 3 is locked/limited inside of 9, that form a cavity once the halves (top connector mold onto the bottom connector mold) are assembled. 10—Details, in three dimensions, the top and bottom halves attachment screw wells, in which, 12—screws, four each, self tap into. 11—Shows an example of a termination connection of 9 pins, thereby giving an overall indications of what type of device to be interfaced, as well as, the sizing requirement of the connector body, but within the preferred embodiment, the balls and socket do not change sizes in relation to the size of an interface. IE, the issue of ball/socket size is related to the interlocking members, while the size of the connector body is relational to the interface's physical size. 13—Solely relates to the preferred opening at the front of an assembled connector, again it's size is relational to the size required by 11. 14 Depicts a three dimensional view of the top and bottom retainer that restricts movement by the interface, depicted by item 11. FIG. 4c 1—Depicts a side view of the socket side connector attached to a system of interlocking members, which 3—, can be of any length chosen. 2—Details a back view of a ball side connector, bottom half, with a TWIST of at least 90-degree, thereby depicting the ability of exact fitting interlocking members allow the semi-rigid bending and twisting properties executed by the preferred embodiment of the Twistable connector and provider assembly. FIG. 4d, displays the abstract assembly of connector ends and interlocking members with cabling inside the structure presented.

I claim,

1. The Twistable connector shall consist of 3 plastic moldings; the left connector, the right connector, and the interlocking member.

2. The interlocking members (ball and socket), claim 1, will be assembled by inserting the ball of one interlocking member (ball and socket) into the socket of an other, which forms a flexible semi-rigid extension between the left (ball) and right (socket) connectors, until a desired length is achieved, then a right connectors attached to the extension's ball side and a left connector is attached to the extension's socket side.

3. A pre-manufactured multi-conductor cable will be inserted within the extension identified in claim 3

4. The cable (claim 4), inside of the extension (claim 3), would be secured to the left and right connector utilizing a fastening retaining clip, thereby providing strain relief

5. The twist (rotational movement) of the overall assembly will be limited by the amount of resistance cause by the strain relief and movement allowed by the cable.

6. The amount of twist of a ball on a socket, (claim 3), is unlimited, except as represented in claim 6 (rotational movement) also the amount of semi-rigid bend would be limited by contact of one interlocking member's socket and the neck of a second interlocking member, whereas the connection would become unattached (angular movement within 3-diminsional space).

7. The top of the left (ball) and right (socket) connector identified in claims 1 and 3 shall be removable to allow cable pinning and assembly.

8. The interlocking member (ball and socket) identified in claim 1 can be of 3 sizes, 1.5″ by 1″ w/½″ hole (model size), and (1.5″ by 1″)*.75 w/⅜″ hole, and (1.5″ by 1″)*.25 w/ 1/4″ hole.

9. The ball on the left connector and socket on the right connector must match the size accepted by the receiving interlocking member listed in claim 9, therefore insuring that an incorporated interface's size remains undisturbed
